(19) United States
(12) Patent Application Publication
(10) Pub. No.: US 2008/0303964 A1
(43) Pub. Date: Dec. 11, 2008

(54) Display substrate and liquid crystal display including the same

(76) Inventors: Kwang-sae Lee, Seoul (KR); Jin-oh Kwag, Suwon-si (KR); Byung-chan Min, Yongin-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/077,380

(22) Filed: Mar. 18, 2008

(30) Foreign Application Priority Data
Jun. 11, 2007 (KR) 10-2007-0056883

(51) Int. Cl. G02F 1/1343; G02F 1/133

(52) U.S. Cl. 349/33; 349/152

(57) ABSTRACT

Provided are a display substrate capable of improving an afterimage phenomenon and a liquid crystal display (LCD) including the display substrate. The display substrate includes a substrate, a low-voltage pad which is formed on the substrate, a ground pad which is formed on the substrate and to which a ground voltage is applied, and a discharge pattern which is formed on the substrate and connects the low-voltage pad and the ground pad.

### CROSS-REFERENCE TO RELATED APPLICATION

This application claims priority from Korean Patent Application No. 10-2007-0056883 filed on Jun. 11, 2007 in the Korean Intellectual Property Office, the disclosure of which is incorporated herein by reference in its entirety.

### BACKGROUND OF THE INVENTION

1. Field of the Invention

The present invention relates to a display substrate capable of improving an afterimage phenomenon, and a liquid crystal display including the display substrate.

2. Description of the Related Art

Generally, liquid crystal displays (LCDs) include a liquid crystal panel provided with a plurality of gate lines and a plurality of data lines, and a driving chip which sequentially provides gate-on and gate-off voltages to the gate lines and a data voltage to the data lines. The liquid crystal panel typically includes a plurality of switching devices which are turned on or off in response to a gate-on voltage or a gate-off voltage and a plurality of pixel electrodes which are charged with a data voltage.

During one frame, the gate-on voltage is applied to each of the gate lines. Then, the gate-off voltage is applied once to each of the gate lines. A plurality of switching devices are turned off in response to the gate-off voltage, and a plurality of pixel electrodes which are charged with a data voltage maintain their voltages for one frame.

When the power supplied to an LCD is cut off, most switching devices are turned off unless a gate-off voltage is quickly discharged to a ground voltage. Therefore, a plurality of pixel electrodes which are charged with a data voltage may not be properly discharged. As a result, an afterimage phenomenon may occur.

### SUMMARY OF THE INVENTION

Aspects of the present invention provide a display substrate that can improve an afterimage phenomenon.

Aspects of the present invention also provide a liquid crystal display (LCD) that can improve an afterimage phenomenon.

However, the aspects of the present invention are not restricted to the one set forth herein. The above and other aspects of the present invention will become apparent to one of daily skill in the art to which the present invention pertains by referencing the detailed description of the present invention given below.

According to an aspect of the present invention, there is provided a display substrate including: a substrate; a low-voltage pad formed on the substrate; a ground pad formed on the substrate and to which a ground voltage is applied; and a discharge pattern which is formed on the substrate and connects the low-voltage pad and the ground pad.

According to another aspect of the present invention, there is provided an LCD including: a liquid crystal panel which is divided into a display portion and a non-display portion, the display portion including a plurality of gate lines, a plurality of data lines, and a plurality of pixels which are respectively formed at intersections between the gate lines and the data lines; and a discharge pattern which is formed on the non-display portion.

According to another aspect of the present invention, there is provided an LCD including: a liquid crystal panel which is divided into a display portion and a non-display portion, the display portion including a plurality of gate lines, a plurality of data lines and a plurality of pixels which are respectively formed at intersections between the gate lines and the data lines, and the non-display portion including a low-voltage pad, a ground pad to which a ground voltage is applied and a discharge resistor which connects the low-voltage pad and the ground pad; and a driving chip which is connected to the low-voltage pad and the ground pad and sequentially provides the gate-off voltage to the gate lines and a data voltage to the data lines.

### BRIEF DESCRIPTION OF THE DRAWINGS

The above and other features and advantages of the present invention will become apparent by describing in detail exemplary embodiments thereof with reference to the attached drawings, in which:

FIG. 1 is a plan view of a display substrate according to an embodiment of the present invention and of a liquid crystal display (LCD) including the display substrate according to another embodiment of the present invention;

FIG. 2 is a block diagram of the LCD illustrated in FIG. 1;

FIG. 3 is an equivalent circuit diagram of a pixel illustrated in FIG. 2;

FIG. 4 is an enlarged plan view of area A of FIG. 1;

FIG. 5A is a cross-sectional view taken along line VA-VA′ of FIG. 4;

FIG. 5B is a cross-sectional view taken along line VB-VB′ of FIG. 4; and

FIG. 6 is a plan view of a display substrate according to another embodiment of the present invention and of an LCD including the display substrate according to another embodiment of the present invention.

### DETAILED DESCRIPTION OF THE EXEMPLARY EMBODIMENTS

The present invention will now be described more fully with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art.

It should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers denote like elements throughout the specification. As used herein the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Furthermore, relative terms such as “below,” “beneath,” or “lower,” “above,” and “upper” may be used herein to describe one element's relationship to another element as illustrated in the accompanying drawings. It will be understood that relative terms are intended to encompass different orientations of the device in addition to the orientation depicted in the accompanying drawings. For example, if the device in the accompanying drawings is turned over, elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the exemplary terms “below” and “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, can be expected. Thus, the disclosed example embodiments of the invention should not be construed as limited to the particular shapes of regions illustrated herein unless expressly so defined herein, but are to include deviations in shapes that result, for example, from manufacturing. Thus, the regions illustrated in the figures are schematic in nature and their shapes are not intended to illustrate the actual shape of a region of a device and are not intended to limit the scope of the invention, unless expressly so defined herein.

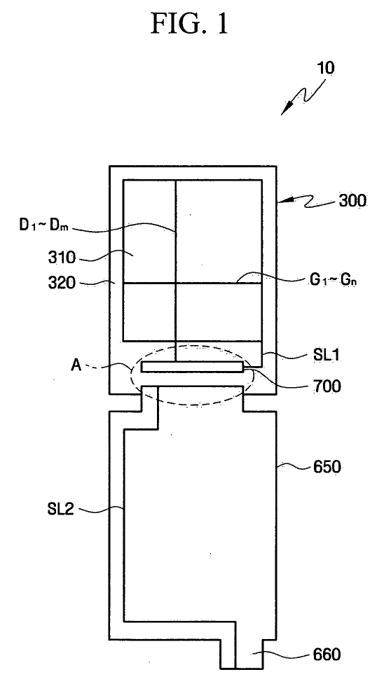

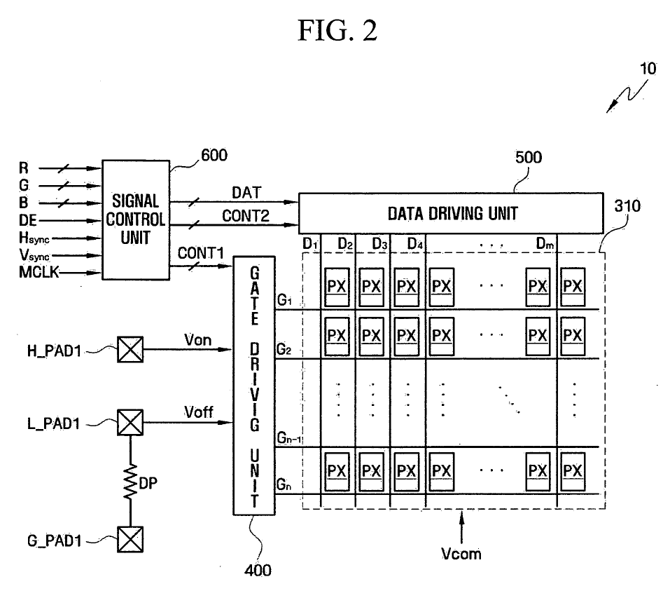

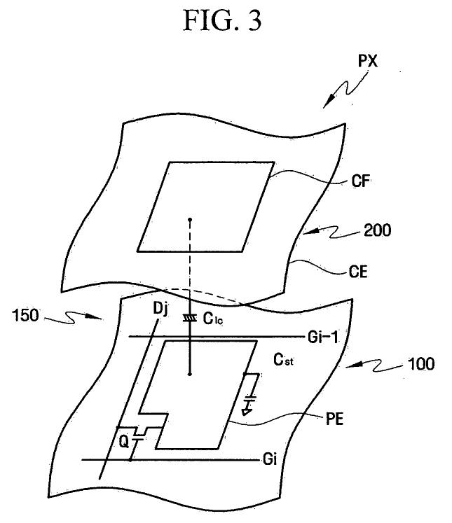

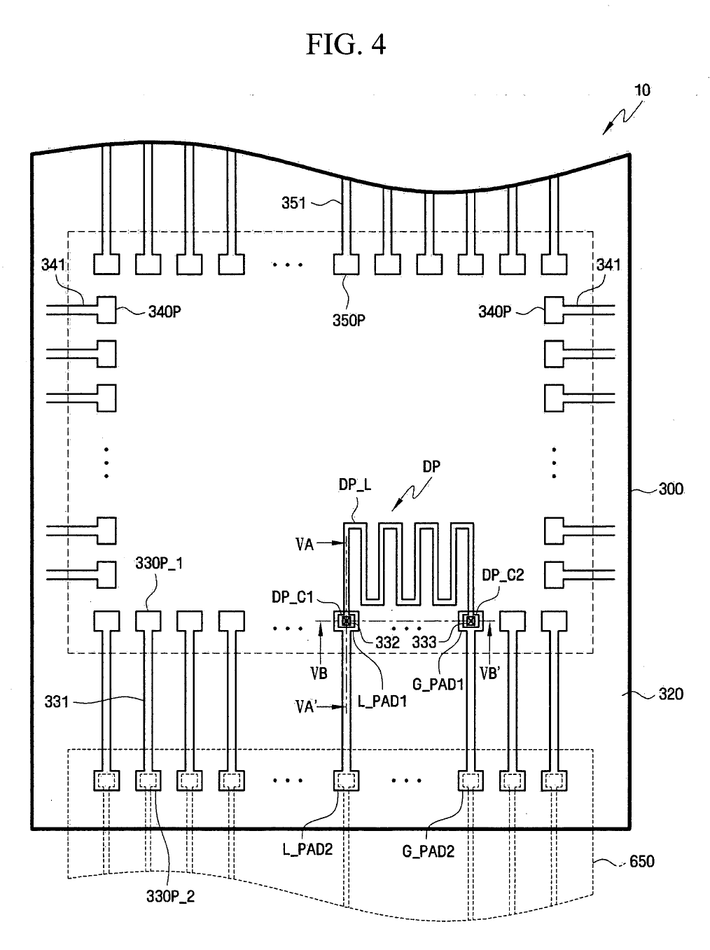

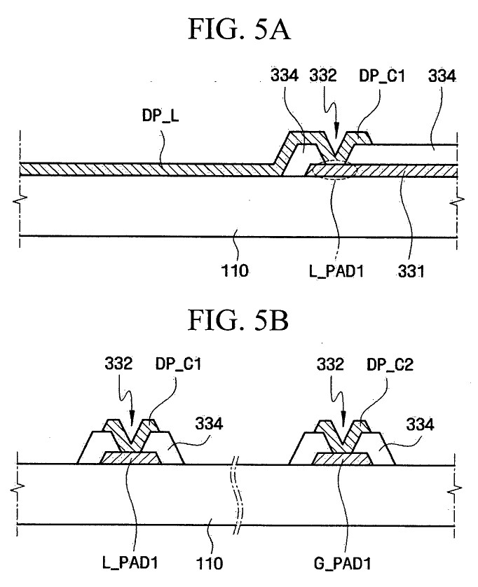

A display substrate according to an embodiment of the present invention and a liquid crystal display (LCD) including the display substrate, according to an embodiment of the present invention will hereinafter be described in detail with reference to FIGS. 1 through 5B. FIG. 1 is a schematic diagram of a display substrate according to an embodiment of the present invention and a liquid crystal display (LCD) 10 including the display substrate, according to an embodiment of the present invention, FIG. 2 is a block diagram of the LCD 10, FIG. 3 is an equivalent circuit diagram of the pixel illustrated in FIG. 2, FIG. 4 is an enlarged plan view of area A of FIG. 1, FIG. 5A is a cross-sectional view taken along line VA-VA′ of FIG. 4, and FIG. 5B is a cross-sectional view taken along line VB-VB′ of FIG. 4.

The LCD 10 includes a liquid crystal panel 300, a driving chip 700 which is mounted on the liquid crystal panel 300, and a flexible printed circuit board 650 which is connected to the liquid crystal panel 300.

The liquid crystal panel 300 is divided into a display portion 310 and a non-display portion 320. Referring to FIG. 2, the display portion 310 includes a plurality of gate lines G₁ through Gₙ, a plurality of data lines D₁ through Dₘ, and a plurality of pixels PX which are respectively disposed at the intersections between the gate lines G₁ through Gₙ and the data lines D₁ through Dₘ. The driving chip 700 is mounted on the non-display portion 320 of the liquid crystal panel 300. The non-display portion 320 is connected to the flexible printed circuit board 650. The driving chip 700 provides a gate-on voltage Von and a gate-off voltage Voff to the gate lines G₁ through Gₙ, and provides a data voltage to the data lines D₁ through Dₘ. The driving chip 700 is connected to the flexible printed circuit board 650 via a signal line SL2.

The display portion 310 will hereinafter be described in further detail with reference to FIGS. 2 and 3. Referring to FIG. 3, the display portion 310 includes a first display substrate 100, a second display substrate 200 and a liquid crystal layer 150 which is interposed between the first display substrate 100 and the second display substrate 200. The display portion 310 includes a plurality of pixels PX which are respectively connected to the gate lines G₁ through Gₙ and to the data lines D₁ through Dₘ, and are arranged in a matrix. The gate lines G₁ through Gₙ extend substantially in a row direction and are parallel to one another. The data lines D₁ through Dₘ extend substantially in a column direction and are parallel to one another.

For example, a pixel PX which is connected to an i-th gate line Gᵢ (where i=1, 2, . . . , n) and a j-th data line Dⱼ (where j=1, 2, . . . , m) includes a switching device Q which is connected to the i-th gate line Gᵢ and the j-th data line Dⱼ and a liquid crystal capacitor C_{1c} which is connected to the switching device Q, and a storage capacitor Cₛₜ. The liquid crystal capacitor C_{1c} includes a pixel electrode PE which is formed on the first display substrate 100, a common electrode CE which is formed on the second display substrate 200 and faces the pixel electrode PE, and liquid crystal molecules which are interposed between the pixel electrode PE and the common electrode CE. A color filter CF may be formed in a predetermined area of the second display substrate 200. The storage capacitor Cₛₜ is optional.

The non-display portion 320 includes a first display substrate 100 and a second display substrate 200. The first display substrate 100 of the non-display portion 320 may be larger than the second display substrate 200 of the non-display portion 320. The driving chip 700 is mounted on the non-display portion 320, and a discharge pattern DP is formed on the non-display portion 320.

The driving chip 700 may be functionally divided into a gate driving unit 400, a data driving unit 500, and a signal control unit 600. That is, referring to FIG. 2, the gate driving unit 400, the data driving unit 500, and the signal control unit 600 may be mounted within the driving circuit 700.

The gate driving unit 400 sequentially applies the gate-off voltage Voff and the gate-on voltage Von to the gate lines G₁ through Gₙ in response to a gate control signal CONT1 provided by the signal control unit 600. The gate control signal CONT1 is a signal for controlling an operation of the gate driving unit 400. Examples of the gate control signal CONT1 include a vertical synchronization start signal which initiates an operation of the gate driving unit 400, a gate clock signal which determines when to output the gate-on voltage Von, and an output enable signal which determines the pulse width of the gate-on voltage Von. The gate driving unit 400 is provided with the gate-off voltage Voff via a first low-voltage pad L_PAD1, and is provided with the gate-on voltage Von via a high-voltage pad H_PAD1. The first low-voltage pad L_PAD1 and the high-voltage pad H_PAD1 are both formed on the non-display portion 320.

The data driving unit 500 is connected to the data lines D₁ through Dₘ of the display portion 310, selects a gray voltage corresponding to a predetermined image signal by being provided with a data control signal CONT2, and applies the selected gray voltage to the data lines D₁ through Dₘ as a data voltage. The data control signal CONT2 is a signal for controlling an operation of the data driving unit 500. Examples of the data control signal CONT2 includes a horizontal start signal which initiates an operation of the data driving unit 500 and an output command signal which commands a data voltage to be output.

The signal control unit 600 receives an input image signal (R, G, and B) and an input control signal for controlling the display of the input image signal (R, G, and B) from the flexible printed circuit board 650. Examples of the input control signal include a vertical synchronization signal V_{sync}, a horizontal synchronization signal H_{sync}, a main clock signal MCLK, and a data enable signal DE.

The signal control unit 600 generates the gate control signal CONT1 and the data control signal CONT2 based on the input image signal (R, G, and B) and the input control signal and transmits the gate control signal CONT1 and the data control signal CONT2 to the gate driving unit 400 and the data driving unit 500, respectively.

The flexible printed circuit board 650 provides a plurality of signals input thereto via an input unit 660 to the driving chip 700 via the signal line SL2. Examples of the signals provided to the driving chip 700 by the flexible printed circuit board 650 include an image signal, the gate-on voltage Von and the gate-off voltage Voff. The flexible printed circuit board 650 may be attached onto the non-display portion 320 of the liquid crystal panel 300 using an anisotropic conductive film.

The first low-voltage pad L_PAD1 to which the gate-off voltage Voff is applied, the high-voltage pad H_PAD1 to which the gate-on voltage Von is applied, a ground pad G_PAD to which a ground voltage is applied, and the discharge pattern DP which connects the first low-voltage pad L_PAD1 and the ground pad G_PAD are all formed on the non-display portion 320. The discharge pattern DP is a resistor connected between the first low-voltage pad L_PAD1 and the ground pad G_PAD. The discharge pattern DP discharges the gate-off voltage Voff to ground when the power supplied to the LCD 10 is cut off. The discharge pattern DP may have a resistance in the range of 80-120 kΩ, but the present invention is not restricted to this.

A plurality of pads and the discharge pattern DP which are all formed on the non-display portion 320 will hereinafter be described in further detail with reference to FIG. 4.

Referring to FIG. 4, the driving chip 700 may be mounted on the non-display portion 320 of the liquid crystal panel 300, as indicated by dotted lines. The driving chip 700 is connected to a plurality of first input pads 330P_1, a plurality of gate output pads 340P which output the gate-on voltage Von and the gate-off voltage Voff, and a plurality of data output pads 350P which output a data voltage. A plurality of second input pads 330P_2 and a plurality of input lines 331 are also formed on the non-display portion 320. The second input pads 330P_2 are connected to the flexible printed circuit board 650. The input lines 331 respectively connect the first input pads 330P_1 to the second input pads 330P_2. The gate output pads 340P are respectively connected to the gate lines G₁ through Gₙ via a plurality of signal lines 341. The data output pads 350P are respectively connected to the data lines D₁ through Dₘ via a plurality of signal lines 351. That is, the driving chip 700 is provided with the gate-on voltage Von, the gate-off voltage Voff, and an image signal via the first input pads 330P_1 and the second input pads 330P_2, performs a signal processing operation, provides the gate-on voltage Von and the gate-off voltage Voff to the display portion 310 via the gate output pads 340P, and provides a data voltage to the display portion 310 via the data output pads 350P.

At least one of the first input pads 330P_1 may be a first low-voltage pad L_PAD1 to which the gate-off voltage Voff is applied. At least one of the first input pads may be a ground pad G_PAD to which a ground voltage is applied. At least one of the second input pads 330P_2 may be a second low-voltage pad L_PAD2 which is connected to the flexible printed circuit board 650 and to which the gate-off voltage Voff is applied. At least one of the second input pads 330P_2 may be a second ground pad G_PAD which is connected to the flexible printed circuit board 650 and to which a ground voltage is applied. The first low-voltage pad L_PAD1 and the first ground pad G_PAD are connected to the discharge pattern DP. The discharge pattern DP can improve an afterimage phenomenon by discharging the gate-off voltage Voff to a ground voltage when the power supplied to the LCD 10 is cut off.

Specifically, the driving chip 700 is connected to the first low-voltage pad L_PAD1. Thus, the gate driving unit 400 of the driving chip 700 is provided with the gate-off voltage Voff by the first low-voltage pad L_PAD1, and then sequentially provides the gate-off voltage Voff to the gate lines G₁ through Gₙ. Since the discharge pattern DP electrically connects the first low-voltage pad L_PAD1 and the ground pad G_PAD, the discharge pattern DP discharges the gate-off voltage Voff to a ground voltage when the power supplied to the LCD 10 is cut off. Therefore, the gate lines G₁ through Gₙ which are electrically connected to the first low-voltage pad L_PAD1 via the driving chip 700 are all discharged to a ground voltage, thereby improving an afterimage phenomenon.

The discharge pattern DP will hereinafter be described in further detail with reference to FIGS. 4 through 5B.

The discharge pattern DP includes a first discharge contact DP_C1 which is connected to the first low-voltage pad L_PAD1, a second discharge contact DP_C2 which is connected to the first ground pad G_PAD, and a discharge line DP_L which connects the first discharge contact DP_C1 and the second discharge contact DP_C2.

Referring to FIGS. 5A and 5B, the first low-voltage pad L_PAD1 and the first ground pad G_PAD are formed on an insulating substrate 110. A passivation layer 334 is formed on the first low-voltage pad L_PAD1 and the first ground pad G_PAD. A plurality of connection holes 332 may be formed through the passivation layer 334 so that the first low-voltage pad L_PAD1 and the first ground pad G_PAD can be partially exposed therethrough. The first discharge contact DP_C1 which is connected to the first low-voltage pad L_PAD1 via a corresponding connection hole 332 and the second discharge contact DP_C2 which is connected to the first ground pad G_PAD via a corresponding connection hole 332 are formed on the passivation layer 334. The first discharge contact DP_C1 and the second discharge contact DP_C2 are connected to the discharge line DP_L. The gate lines G₁ through Gₙ and the data lines D₁ through Dₘ are formed on the display portion 310 of the insulating substrate 110.

The discharge line DP_L may be formed in a serpentine shape, as illustrated in FIG. 4, but the present invention is not restricted to this. The first low-voltage pad L_PAD1, the first ground pad G_PAD, and the discharge pattern DP may all be formed of a conductive material, for example, aluminum (Al) or an aluminum-based metallic material such as an aluminum alloy, silver (Ag) or a silver-based metallic material such as a silver alloy, copper (Cu) or a copper-based metallic material such as a copper alloy, molybdenum (Mo) or a molybdenum-based metallic material such as a molybdenum alloy, chromium (Cr), titanium (Ti), or a tantalum (Ta). More specifically, the discharge pattern DP may be formed of indium tin oxide (ITO) which has a high surface resistance. In this case, the discharge pattern DP may be formed during the formation of the pixel electrode PE of the display portion 310.

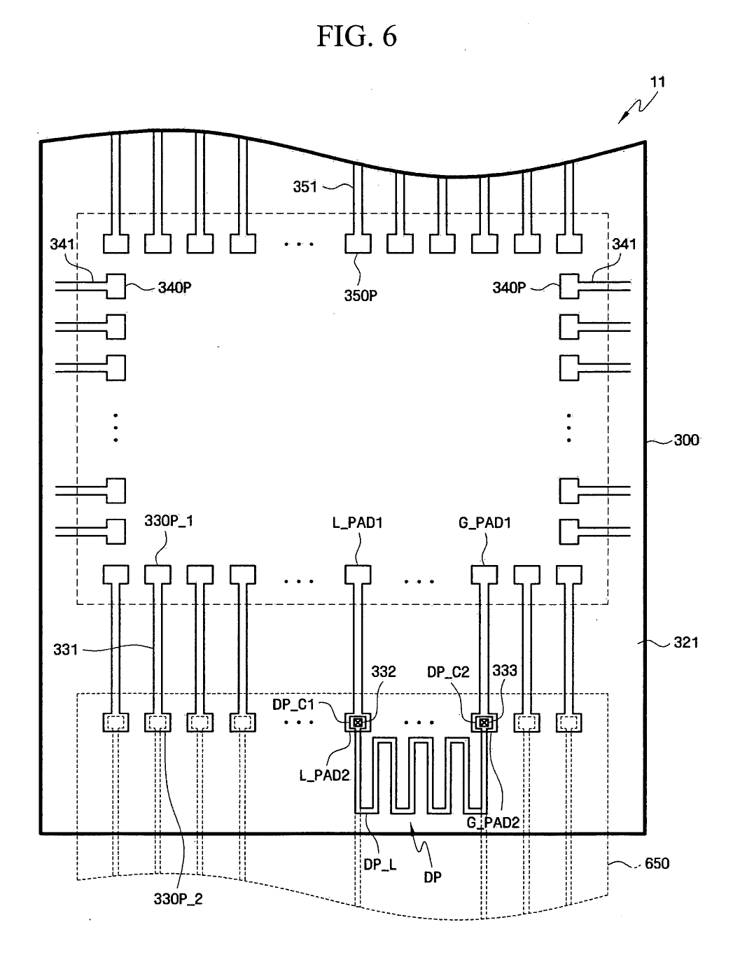

A display substrate according to another embodiment of the present invention and an LCD including the display substrate, according to another embodiment of the present invention is described below in detail with reference to FIG. 6. FIG. 6 is a plan view of a display substrate according to another embodiment of the present invention, and an LCD 11 including the display substrate according to another embodiment of the present invention. In FIGS. 4 and 6, like reference numerals represent like elements, and thus detailed descriptions thereof is not required.

Referring to FIG. 6, a discharge pattern DP, unlike the discharge pattern DP of the embodiment of FIG. 4, is formed on a portion of a liquid crystal panel 300 to which a flexible printed circuit board 650 is attached. That is, the discharge pattern DP electrically connects a second low-voltage pad L_PAD2 and a second ground pad G_PAD which are both formed on the liquid crystal panel 300. The discharge pattern DP can improve an afterimage phenomenon by discharging a gate-off voltage to a ground voltage when the power supplied to the LCD 11 is cut off.

As described above, according to the present invention, it is possible to improve an afterimage phenomenon.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display substrate comprising:
a substrate;
a voltage pad formed on the substrate;
a ground pad formed on the substrate; and
a discharge pattern formed on the substrate, the discharge pattern being connected to the voltage pad and the ground pad.

2. The display substrate of claim 1, wherein the discharge pattern comprises: a first discharge contact connected to the voltage pad, a second discharge contact connected to the ground pad, and a discharge line connected to the first discharge contact and the second discharge contact in a serpentine shape.

3. The display substrate of claim 2, wherein:
the first discharge contact is formed on the voltage pad; and
the second discharge contact is formed on the ground pad.

4. The display substrate of claim 1, wherein the discharge pattern comprises at least one of chromium (Cr) and indium tin oxide (ITO).

5. The display substrate of claim 1, wherein the discharge pattern has a resistance in the range of about 80 kΩ-120 kΩ.

6. The display substrate of claim 1, further comprising:
a plurality of gate lines formed on the substrate;
a plurality of data lines formed on the substrate; and
a plurality of pixels respectively formed at intersections between the gate lines and the data lines.

7. The display substrate of claim 1, wherein a gate-off voltage is applied to the voltage pad.

8. A liquid crystal display (LCD) comprising:
a liquid crystal panel having a display portion and a non-display portion, the display portion including a plurality of gate lines, a plurality of data lines and a plurality of pixels; and
a discharge pattern formed on the non-display portion.

9. The LCD of claim 8, wherein the discharge pattern discharges to a ground a gate-off voltage which is applied to the gate lines.

10. The LCD of claim 8, wherein the discharge pattern comprises a first discharge contact to which a gate-off voltage is applied, a second discharge contact connected to ground, and a discharge line connected to the first discharge contact and the second discharge contact.

11. The LCD of claim 8, wherein:
the non-display portion includes a first voltage pad to which a gate-off voltage is applied and a first ground pad, and
the LCD further comprises a driving chip connected to the first voltage pad and to the first ground pad, the driving chip sequentially providing a gate-off voltage to the gate lines and a data voltage to the data lines.

12. The LCD of claim 11, wherein the discharge pattern is connected to the first voltage pad and the first ground pad.

13. The LCD of claim 12, wherein the discharge pattern comprises a first discharge contact which is formed on the first voltage pad, a second discharge contact which is formed on the first ground pad, and a discharge line which connects the first discharge contact and the second discharge contact.

14. The LCD of claim 11, wherein:
the non-display portion includes a second voltage pad connected to the first voltage pad and a second ground pad which is connected to the first ground pad; and
the LCD further comprises a circuit board which is connected to the second voltage pad and the second ground pad, and provides the gate-off voltage and the ground voltage.

15. The LCD of claim 14, wherein the discharge pattern connects the second voltage pad and the second ground pad.

16. The LCD of claim 15, wherein the discharge pattern comprises a first discharge contact which is formed on the second voltage pad, a second discharge contact which is formed on the second ground pad, and a discharge line which connects the first discharge contact and the second discharge contact.

17. The LCD of claim 8, wherein the discharge pattern comprises at least one of chromium (Cr) and ITO.

18. The LCD of claim 8, wherein the discharge pattern has a resistance in the range of from about 80 kΩ-120 kΩ.

19. A liquid crystal display (LCD) comprising:
a liquid crystal panel divided into a display portion and a non-display portion, the display portion including a plurality of gate lines, a plurality of data lines and a plurality of pixels, wherein the non-display portion includes a voltage pad, a ground pad and a discharge resistor which connects the voltage pad and the ground pad; and
a driving chip connected to the voltage pad and the ground pad, the driving chip sequentially providing the gate-off voltage to the gate lines and a data voltage to the data lines.

20. The LCD of claim 19, wherein a negative gate-off voltage is applied to the voltage pad.

21. The LCD of claim 19, wherein the discharge resistor is made of conductive metal and is formed in a serpentine shape.

22. The LCD of claim 19, wherein the discharge resistor has a resistance in the range of from about 80 kg-120 kΩ.
